(19) United States
(12) Patent Application Publication
(10) Pub. No.: US 2016/0148548 A1
(43) Pub. Date: May 26, 2016

(54) METHOD AND SYSTEM FOR MANAGING DISPLAY OF MULTIMEDIA INFORMATION ON A PERSISTENCE OF VISION (POV) BASED DISPLAY

(71) Applicant: PAVAN PUDIPEDDI, AUSTIN, TX (US)

(72) Inventor: PAVAN PUDIPEDDI, AUSTIN, TX (US)

(21) Appl. No.: 14/744,429

(22) Filed: Jun. 19, 2015

Related U.S. Application Data
(63) Continuation-in-part of application No. 14/583,095, filed on Dec. 25, 2014.
(60) Provisional application No. 62/014,144, filed on Jun. 19, 2014.

(51) Int. Cl. G09G 3/00

(52) U.S. Cl. CPC G09G 3/005; G09G 2370/16; G09G 2330/02

(57) ABSTRACT

Embodiments of the present invention disclose a system for managing display of multimedia information, and a method therefor. The system comprises a Persistence Of Vision (POV) based display subsystem facilitating display of at least one of contextual and non-contextual multimedia information, a microcomputer subsystem coupled to the POV based display subsystem for processing the at least one of contextual and non-contextual multimedia information, an illumination subsystem for displaying the at least one of contextual and non-contextual multimedia information, a portable computing and communication device for accessing and transmitting the at least one of contextual and non-contextual multimedia information from and to the microcomputer subsystem coupled to the POV display subsystem and an external network for transmitting the at least one of contextual and non-contextual multimedia information to the microcomputer subsystem coupled to the POV display subsystem.

### CROSS-REFERENCE TO RELATED APPLICATIONS

This application claims the benefit of which is hereby incorporated by reference in its entirety: U.S. Provisional Patent Application No. 62/014,144, captioned “METHOD AND SYSTEM FOR MANAGING DISPLAY OF MULTIMEDIA INFORMATION ON A PERSISTENCE OF VISION (POV) BASED DISPLAY” filed Jun. 19, 2014. This application is a continuation-in-part of U.S. Non-Provisional patent application Ser. No. 14/583,095, captioned “METHOD AND SYSTEM FOR SIMULTANEOUSLY WIRELESSLY CHARGING PORTABLE RECHARGEABLE DEVICES BASED ON WIRELESS INDUCTIVE POWER TRANSFER WITH SEAMLESS FREE POSITIONING CAPABILITY” filed Dec. 25, 2014.

### BACKGROUND OF THE INVENTION

1. Field of the Invention

Embodiments of the present invention generally relate to Persistence of Vision (POV) based displays, and more particularly, to adaptively and dynamically managing display of at least one of non-contextual and contextual multimedia information on the Persistence of Vision (POV) based display depending upon at least one of a current context associated with the POV based display and the multimedia information obtained from external content sources in one or more networks involving wireless power transfer thereof with enhanced qualitative and quantitative parameters, such as economical, easy and enhanced usability, enhanced User Experience (UX), high level of interactivity and customizability.

2. Description of the Related Art

The “after image effect” or the “Persistence Of Vision (POV)” of the human eye is well known as a viable means of delivering readable displays to the brain. Devices, which have been used to produce such displays display small portions of an image at different times and locations, thus relying on the human brain to retain the momentary images and combine them into a whole picture. Such displays are visibly pleasing and seem to appear and hang in mid-air. Motion is an integral part of the production of an “after image” display. The device, which produces the display, may be moved through space or the observer may be moved. Either way, the phenomenon is effective and visual displays become perceptible by the brain.

Bell U.S. Pat. No. 4,470,044 teaches that saccadic eye movements can produce visual displays without moving the display device, but this is only effective when viewed at a distance, since minute eye movements cannot scan the required space when viewed in close proximity.

The “after image effect” relies on partial images delivered to the brain in rapid succession.

The human brain must retain the partial images long enough to construct a meaningful image out of them. The faster the partial images are presented to the eye/brain, the faster the brain can make sense of the image and perceive a visual display.

Highly complicated and costly apparatus has been employed as in Belcher et al. U.S. Pat. No. 5,302,965 and in Sokol U.S. Pat. No. 4,689,604 to deliver precisely timed displays in order to attempt a stable display. Not only are the apparatus costly, but if they are not precisely synchronized with the motion of the display device, the display will not be stable and pleasing.

Prior art has been heavy, cumbersome, and limited to a vertical row of light emitting elements, which limits the size and shape of the device.

Prior art has not be able to display large displays, or communicate large phrases, since they are limited to what can be displayed in one swing.

Determining what is to be displayed by prior art is complicated and time consuming. Data selection has been accomplished with complicated push button selection schemes without user feedback to verify correct programming. Users of the devices quickly become frustrated with the complicated device and lose interest in using it. Some devices have provided means for users to enter user defined display data. These means all suffer from highly complicated methods and means, which confuse and discourage users.

Therefore, there is still a need for the design and implementation of systems for adaptively and dynamically managing display of at least one of non-contextual and contextual multimedia information on the Persistence of Vision (POV) based display depending upon at least one of a current context associated with the POV based display and the multimedia information obtained from external content sources in one or more networks involving wireless power transfer thereof with enhanced qualitative and quantitative parameters, such as economical, easy and enhanced usability, enhanced User Experience (UX), high level of interactivity and customizability, and methods therefor.

### SUMMARY OF THE INVENTION

Embodiments of the present invention disclose a system for managing display of multimedia information, and a method therefor. The system comprises a Persistence Of Vision (POV) based display subsystem facilitating display of at least one of contextual and non-contextual multimedia information, a microcomputer subsystem coupled to the POV based display subsystem for processing the at least one of contextual and non-contextual multimedia information, an illumination subsystem for displaying the at least one of contextual and non-contextual multimedia information, a portable computing and communication device for accessing and transmitting the at least one of contextual and non-contextual multimedia information from and to the microcomputer subsystem coupled to the POV display subsystem and an external network for transmitting the at least one of contextual and non-contextual multimedia information to the microcomputer subsystem coupled to the POV display subsystem.

Embodiments of the present invention disclose a method for managing display of multimedia information. The method comprises displaying at least one of contextual and non-contextual multimedia information on a Persistence Of Vision (POV) based display subsystem, processing the at least one of contextual and non-contextual multimedia information using a microcomputer subsystem coupled to the POV based display subsystem, displaying the at least one of contextual and non-contextual multimedia information using an illumination subsystem coupled to the POV based display subsystem, accessing and transmitting the at least one of contextual and non-contextual multimedia information from and to the microcomputer subsystem coupled to the POV display subsystem using a portable computing and communication device, and transmitting the at least one of contextual and non-contextual multimedia information to the microcomputer subsystem coupled to the POV display subsystem using an external network.

In some embodiments, the method may facilitate capturing (storing) overall profiles of the users of the POV based display subsystem, analyzing the captured overall profiles, profiling the users based on the analysis of the captured overall profiles, categorizing the users based on the profiling, utilizing the categorization information and contextual information in a given location in which the POV based display subsystem may be confined for building a current ambient context and rendering recommendations in connection with selection and display of one or more available multimedia information based on the categories of the users and current ambient context. For instance, the overall profile of the users may comprise at least one of name, age, sex, marital status, family type, such as joint or nuclear, profession, past usage history and behaviour of the POV based display subsystem, subscriptions to one or more LBA programs, buying or purchasing behaviour, hobbies, likes or dislikes, daily routine, and the rest.

These and other systems, processes, methods, objects, features, and advantages of the present invention will be apparent to those skilled in the art from the following detailed description of the preferred embodiment and the drawings All documents mentioned herein are hereby incorporated in their entirety by reference.

### BRIEF DESCRIPTION OF THE DRAWINGS

FIG. 1 depicts a block diagram of the system for adaptively and dynamically managing display of multimedia information on the POV based display subsystem, according to one or more embodiments;

FIG. 2 depicts the POV based display subsystem as a micro-computerized fan, according to one or more embodiments;

FIG. 3 depicts a method for managing display of multimedia information, according to one or more embodiments;

FIG. 4 depicts the architecture of a sensor node constituting the Wireless Sensor Network (WSN), according to one or more embodiments; and

FIG. 5 depicts a computer system that is at least one of a portable computing and communications device and a computer and can be utilized in various embodiments of the present invention, according to one or more embodiments.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the improved method and system for managing display of multimedia information on a Persistence Of Vision (POV) based display, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the improved method and system for managing display of multimedia information on a Persistence Of Vision (POV) based display defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Various embodiments of a method and system for managing display of multimedia information on a Persistence of Vision (POV) based display are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

In some embodiments, a system facilitating adaptively and dynamically managing display of multimedia information on a Persistence of Vision (POV) based display subsystem thereof is disclosed, in accordance with the principles of the present invention. Specifically, the system may facilitate adaptively and dynamically managing display of at least one of context-independent (or non-contextual) and context-dependent (or contextual) multimedia information based on at least one of a current context associated with the POV based display subsystem and the multimedia information obtained from one or more external content sources in one or more networks. More specifically, the system may facilitate at least one of wireless power and data transfer to an illumination subsystem thereof using a wireless power transfer subsystem and a wireless network.

Embodiments of the present invention disclose a system for managing display of multimedia information, and a method therefor. The system comprises a Persistence of Vision (POV) based display subsystem facilitating display of at least one of contextual and non-contextual multimedia information, a microcomputer subsystem coupled to the POV based display subsystem for processing the at least one of contextual and non-contextual multimedia information, an illumination subsystem facilitating displaying the at least one of contextual and non-contextual multimedia information, a portable computing and communication device for accessing and transmitting the at least one of contextual and non-contextual multimedia information from and to the microcomputer subsystem coupled to the POV display subsystem and an external network for transmitting the at least one of contextual and non-contextual multimedia information to the microcomputer subsystem coupled to the POV display subsystem.

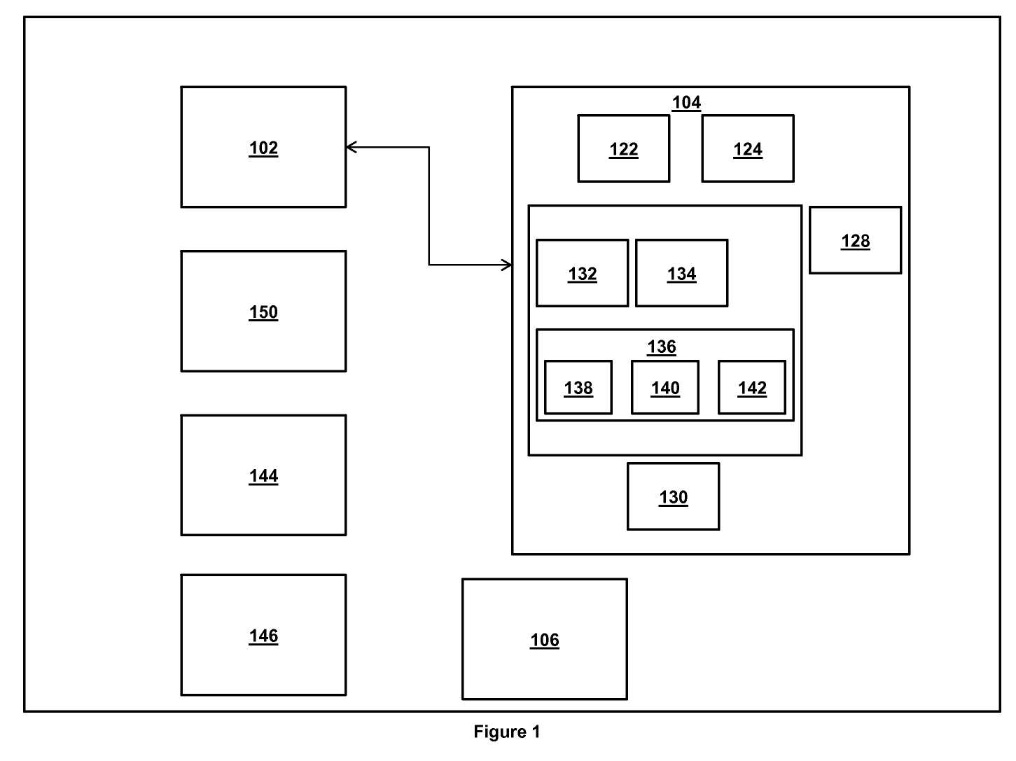

FIG. 1 depicts a block diagram of the system for adaptively and dynamically managing display of multimedia information on the POV based display subsystem, according to one or more embodiments.

The system 100 may comprise a POV based display subsystem 102, microcomputer subsystem 104, an illumination subsystem 150, one or more portable computing and communications devices 106 and one or more wireless networks 108 (not shown here explicitly).

In some embodiments, the POV based display subsystem may be capable of facilitating display of multimedia information, for instance at least one of textual messages, images (or visuals, or image patterns), animations, videos and a combination thereof, which is at least one of transmitted from one or more portable computing and communications devices and pushed from the external content sources hosted by location-based advertisers in one or more networks.

In some embodiments, for example, and in no way limiting the scope of the invention, the POV based display subsystem may be designed and implemented using a mechanical fan.

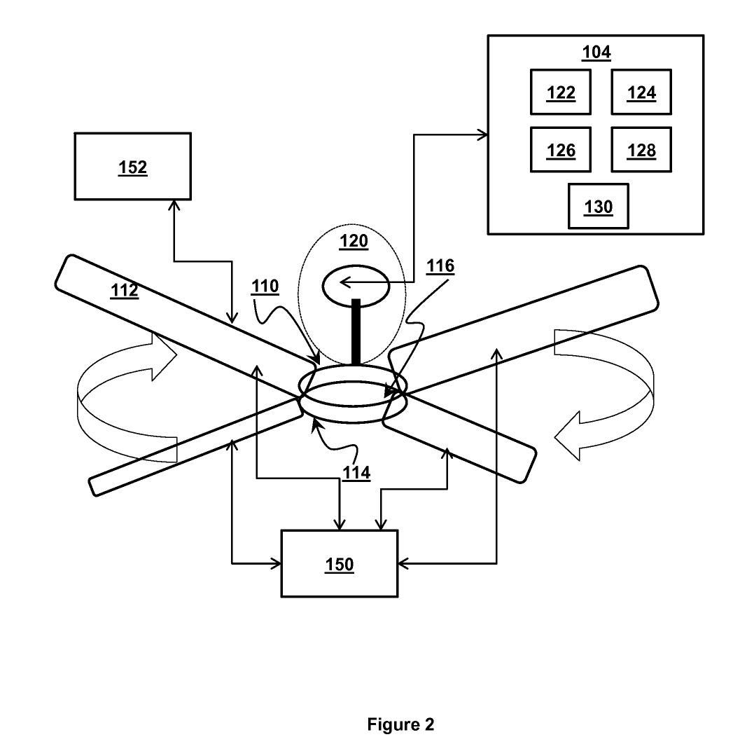

FIG. 2 depicts the POV based display subsystem as a micro-computerized fan, according to one or more embodiments.

By virtue of design, the POV based display subsystem 102 is a mechanical fan. For example, and in no way limiting the scope of the invention, the fan 102 may be at least one of an electrically powered mechanical and micro-computerized fan. For purposes of clarity and expediency, the mechanical fan 102 facilitating realization of the POV based display subsystem may be hereinafter referred to as fan. Specifically, in operation, the blade span (or blade sweep) of the fan may be capable of serving as a medium for displaying the multimedia information.

The fan 102 may comprise an electric motor 110, one or more blades 112, metal arms 114, flywheel 116, rotor 118 (not shown here explicitly) and a fan mounting subsystem 120.

In some embodiments, the fan may be a micro-computerized fan. In some embodiments, the microcomputer subsystem may be at least one of fixedly removably coupled to at least one of a full-custom designed fan and retrofitted to at least one of an conventional fan and semi-custom designed fan.

In some embodiments, the microcomputer subsystem may be capable of facilitating overall management of multimedia information received by the fan. Specifically, the microcomputer subsystem may be capable of managing display of multimedia information on the fan. Further, the microcomputer subsystem may facilitate building a current context associated with the fan.

As used herein, the term “current context” refers to at least one of the current location or position of a POV based display subsystem, for instance the fan 102, the current ambience relative to the location of the POV based display subsystem, the contents currently being displayed on the POV based display subsystem, the current time period and push type location-based advertisements currently available (or ready to display), and a combination thereof. Of note here is the fact that the current definiens used hereinabove to describe the definiendum, i.e. “current context”, in the definition is not limited to the current definiens and that the definiendum may comprise one or more additional definiens (or definientia).

In some embodiments, as depicted in FIG. 1, the microcomputer subsystem 104 may comprise a micro-processing unit 122, an I/O unit 124, a memory unit 126 and a set of support circuits 128. In some embodiments, the microcomputer subsystem 122 may comprise of a first wireless communication transceiver 130.

In some embodiments, the first wireless communication transceiver 130 may be wirelessly coupled to one or more sensors (not explicitly shown and numbered herein). For example, and in no way limiting the scope of the invention, the one or more sensors may be at least one of acoustic, sound, or vibration sensors, for instance a microphone; chemical sensors, for instance a Carbon Dioxide (CO2) sensor, Carbon Monoxide (CO) detector, electrochemical gas sensor, electronic nose, hydrogen sensor, olfactometer, oxygen sensor (or lambda sensor), smoke detector, and a combination thereof; electric current, electric potential, magnetic, or radio sensors, for instance a current sensor, voltage detector and a combination thereof; environment, weather, moisture, or humidity sensors, for instance a wireless bedwetting alarm, gas detector, humistor, hygrometer, and a combination thereof; position, angle, displacement, distance, speed, or acceleration sensors, for instance, a photoelectric sensor, position sensor, and a combination thereof; proximity, or presence sensors, for instance an alarm sensor, motion detector, an occupancy sensor, a proximity sensor, Passive Infrared Sensor (PIR) sensor, triangulation sensors, touch switch, and a combination thereof, and the rest.

In some embodiments, in use, at least one of an individual sensor and a combination thereof may capture corresponding one or more physical quantities in the form of analog signals. In some embodiments, an Analog-to-Digital Converter (ADC) may convert the analog signals into corresponding digital signals, i.e. digital representation of the analog signals. The digital signal(s) may be readable by any suitable electronic device.

In some embodiments, in operation, the one or more digital signals from the one or more sensors may be received by the first wireless communication transceiver. The micro-processing unit may facilitate processing of the digital signals. The memory unit of the microcomputer subsystem may be capable of storing the digital representation of the analog signals in the form of context (related) information.

In some embodiments, the microcomputer subsystem 104 may be coupled to the POV based display subsystem, for instance the fan 102. Specifically, the microcomputer subsystem 104 may be at least one of fixedly removably coupled to at least one of a full-custom designed fan 102 and retrofitted to at least one of the blades 112, metal arms 114, flywheel 116, rotor 118 and the fan mounting subsystem 120 of at least one of an conventional and semi-custom designed fan 102. More specifically, for example, and in no way limiting the scope of the invention, as depicted in FIG. 2, the microcomputer subsystem 104 may be at least one of fixedly removably coupled to the full-custom designed fan 102 and retrofitted to the fan mounting subsystem 120 of at least one of the conventional and semi-custom designed fan 102.

In some embodiments, the memory unit may be capable of facilitating storage and management of multimedia information. The memory unit may be capable of facilitating storage and implementation of proprietary application software and Database Management System (DBMS) thereby facilitating overall management of multimedia information. For purposes of clarity and expediency, the proprietary application software may be hereinafter interchangeably referred to as at least one of the proprietary application software and multimedia information management module.

As depicted in FIG. 1, the memory unit 126 may comprise an Operating System (OS) 132, a multimedia information management module 134 and a DBMS 136. For example, and in no way limiting the scope of the invention, the OS 132 may be a Reduced Instruction Set Computing (RISC) OS, for instance RISC/OS™. For example, and in no way limiting the scope the invention, the DBMS 136 may be an at least one of a micro and pico DBMS 136.

In some embodiments, the DBMS may be capable of facilitating storage and management of the multimedia information in the form of one or more records. Specifically, each individual record may be stored in a database, wherein each individual record may comprise one or more attributes or fields. More specifically, the one or more attributes may comprise multimedia information and corresponding metadata therefor. The DBMS may be capable of facilitating at least one of sequential, random and customized searching (or scanning) of one or more records comprising multimedia information and corresponding metadata therefor, based on one or more criterion, for instance explicit user-definable criteria.

In some embodiments, the aforementioned criteria in connection with the records comprising multimedia information may be based on at least one of current location and position of the POV based display subsystem, for instance the fan 102, the current ambience relative to the location of the POV based display subsystem, the contents currently being displayed on the POV based display subsystem, the current time period and push type location-based advertisements currently available (or ready to display), and a combination thereof.

In some scenarios, for example, and in no way limiting the scope of the invention, the current location of the POV based display subsystem, for instance the fan 102, may be in a bedroom, the current time period may be at least one of morning, afternoon, evening, midnight and night, the current ambience relative to the location of the POV based display subsystem may comprise of data or values of one or more quantitative and qualitative parameters, such as at least one of the ambient temperature with a value that may be at least one of below, above and at room temperature; the humidity may be at least of below, above and at normal; the number of occupants is at least one of low, medium and high; the intensity of sound and the level of noise may be at least of below, above and at normal; the intensity of ambient light may be at least of below, above and at normal; the motion or movement in the bedroom may be at least one of absent and present, and the rest.

In some scenarios, for example, and in no way limiting the scope of the invention, the current location of the POV based display subsystem, for instance the fan 102, may be in a bedroom, the current time period may be at least one of morning, afternoon, evening, midnight and night, the push type location-based advertisements currently available or ready for display on the POV based display subsystem may comprise of at least one of textual, visual (or graphical), audio, multimedia advertisements and a combination thereof based on the nature of contents.

In some embodiments involving push-based Location-Based Advertising (LBA), users, for instance fan owners, users or operators, may opt-into via registering for a given LBA program offered by a given location-based advertisement content service provider. The Location-based advertising (LBA) may facilitate integrating mobile advertising with Location-Based Services (LBS). The LBA may facilitate pinpointing the location of the users, for instance fan owners, users or operators, and providing location-specific advertisements on the POV based display subsystem, for instance the fan 102. In some scenarios, users may register for the given LBA program offered by the given location-based advertisement content service provider via the website (or portal) of, or hosted by, a seller or at an online store. Upon registration, users may be requested to provide their personal information, such as mobile phone number, first name, and other related information. Upon submission of the personal information, the company may send a message requesting users to confirm back the LBA subscription. Upon completion of any and all requisite formalities in connection with LBA subscription, the company may use location based technology to provide customers with location based offers and incentives.

As depicted in FIG. 1, the DBMS 136 may comprise a front end application 138, backend application 140 and backend database 142. For example, and in no way limiting the scope of the invention, the front end and backend applications 138 and 140 may correspondingly serve as the client-side front end and server-side backend for the multimedia information management module 134. Further, for example, and in no way limiting the scope of the invention, the backend database 140 may be an In-Memory (IMDB), also Main Memory Database System (MMDB) (or memory resident database) 140.

In some embodiments, the front end application may be capable of collecting input in various forms from the user, for instance through a customized Graphical User Interface (GUI) rendered on a portable computing and communications device owned by the user, and processing the same to conform to a specification both the back end application and database may be capable of consuming. The front end application may be capable of serving as an interface between the user and the backend application and database. In some embodiments, the front end and backend applications may be correspondingly distributed amongst one or more clients, for instance the portable computing and communications devices 106, and servers, for instance the memory unit 126 in the microcomputer subsystem 104 of the fan 102. For purposes of clarity and expediency, the front end application may be hereinafter referred to as client-side front end application.

In some embodiments, the backend database may be capable of storing multimedia information received from the portable computing and communications device. In some embodiments, the backend database may be capable of storing multimedia information pushed to the fan from one or more servers in a network, based on the location of the fan. In some embodiments, one or more portable computing and communications devices may be capable of sending at least one of text and visual messages via the Short Message Service (SMS) to the fan.

In some embodiments, the backend database may be capable of storing multimedia information received from the portable computing and communications devices. In some embodiments, the backend database may be capable of storing multimedia information pushed to the fan from one or more servers in a network, based on the location of the fan. In some embodiments, one or more portable computing and communications devices may be capable of sending at least one of textual, visual, voice and multimedia messages via the Short Message Service (SMS) and the Multimedia Message Service (MMS) to the fan.

As depicted in FIG. 1, in some embodiments, the POV based display subsystem, for instance the fan 102, may comprise may comprise a positioning subsystem, for instance a Global Positioning System (GPS) Unit 144, and a packet-oriented data transmission and reception service, for instance rendered via a General Packet Radio Service (GPRS) unit 146. In some embodiments, the fan 102 may comprise a second wireless communication transceiver 148.

The GPS unit (or GPS receiver unit) 144 may be capable of facilitating determination of position or location of the fan 102 with respect to a given geographic location.

The GPRS unit 148 may be capable of facilitating transmission and reception (or exchange) of at least one of visual, video, data, facsimile and multimedia messages or information between one or more remote portable computing and communications devices 106, networks 108 and the fan 102.

In some embodiments, the illumination subsystem may be capable of at least one of partly and fully illuminating the blade span (or blade sweep) of the fan, thereby serving as a medium for displaying the multimedia information. The illumination subsystem may be capable of displaying one or more multimedia information.

The illumination subsystem 150 may comprise a physical configuration of Light Emitting Diodes (LEDs). As depicted in FIG. 2, the physical configuration of LEDs may be capable of being at least one of detachably or removably retrofitted and integrated with the blades 112 of the fan 102. In some embodiments, the physical configuration of LEDs 150 may be customizable and at least one of disposable and reusable.

In some embodiments, design and implementation of a wireless power transfer subsystem for supplying wireless power to the physical configuration of LEDs coupled to each of the fan blades is disclosed, in accordance with the principles of the present invention. Specifically, one or more transmitter coils may be fixedly removably coupled to the mounting subsystem of the fan, whereas the physical configuration of LEDs coupled to each of the fan blades may be fixedly removably coupled to one or more receiver coils. In operation, upon at least one of intermittent positioning (or presence) and approach of each of the fan blades in at least one of proximity and vicinity of the transmitter coils, the receiver coils receive power wirelessly from the transmitter coils.

The wireless power transfer subsystem 152 (not shown here explicitly) may comprise one or more transmitter coils 154 (not shown here explicitly) and one or more corresponding receiver coils 156 (not shown here explicitly). As depicted in FIG. 2, the wireless power transfer subsystem 152 may be fixedly removably coupled to the POV based display subsystem, for instance the fan 102. Specifically, the one or more transmitter coils 154 may be fixedly removably coupled to the fan mounting subsystem 120, whereas the physical configuration of LEDs 150 coupled to each of the blades 112 of the fan 102 may be fixedly removably coupled to one or more receiver coils 156.

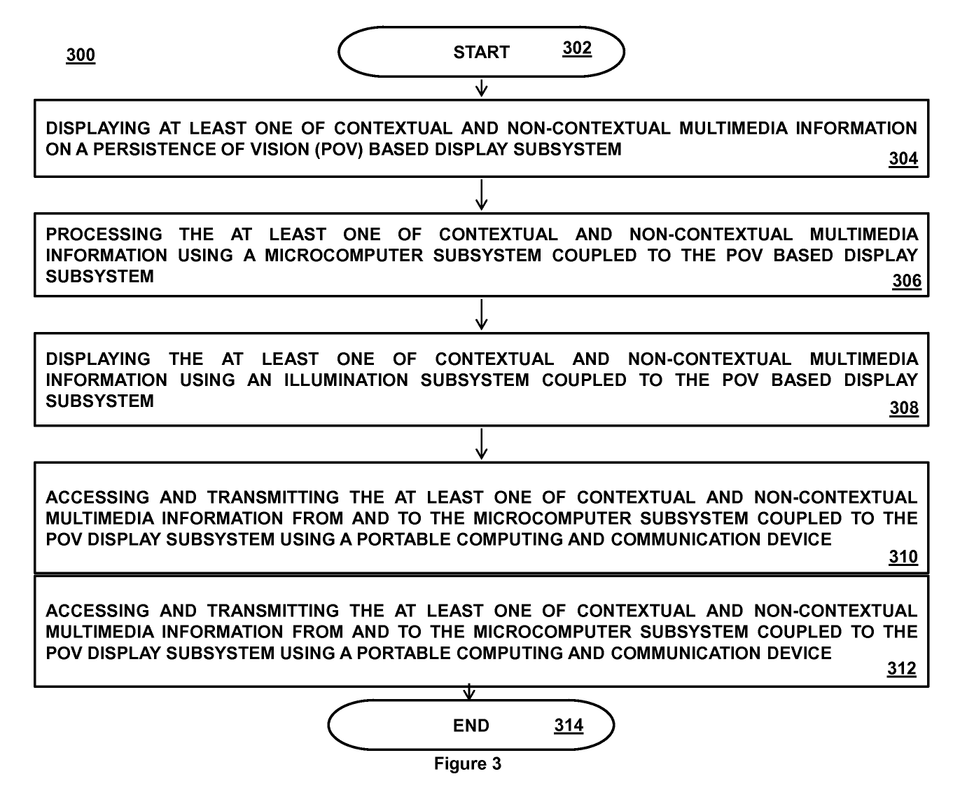

FIG. 3 depicts a method for managing display of multimedia information, according to one or more embodiments.

The method 300 starts at step 302 and proceeds to step 304.

At step 304, the method 300 may comprise, or facilitate, displaying at least one of contextual and non-contextual multimedia information on a Persistence Of Vision (POV) based display subsystem.

At step 306, the method 300 may comprise, or facilitate, processing the at least one of contextual and non-contextual multimedia information using a microcomputer subsystem coupled to the POV based display subsystem.

At step 308, the method 300 may comprise, or facilitate, displaying the at least one of contextual and non-contextual multimedia information using an illumination subsystem coupled to the POV based display subsystem.

At step 310, the method 300 may comprise, or facilitate, accessing and transmitting the at least one of contextual and non-contextual multimedia information from and to the microcomputer subsystem coupled to the POV display subsystem using a portable computing and communication device.

At step 312, the method 300 may comprise, or facilitate, transmitting the at least one of contextual and non-contextual multimedia information to the microcomputer subsystem coupled to the POV display subsystem using an external network.

At step 314, the method 300 ends.

In some embodiments, the method 300 may facilitate capturing (storing) overall profiles of the users of the POV based display subsystem, analyzing the captured overall profiles, profiling the users based on the analysis of the captured overall profiles, categorizing the users based on the profiling, utilizing the categorization information and contextual information in a given location in which the POV based display subsystem may be confined for building a current ambient context and rendering recommendations in connection with selection and display of one or more available multimedia information based on the categories of the users and current ambient context. For instance, the overall profile of the users may comprise at least one of name, age, sex, marital status, family type, such as joint or nuclear, profession, past usage history and behaviour of the POV based display subsystem, subscriptions to one or more LBA programs, buying or purchasing behaviour, hobbies, likes or dislikes, daily routine, and the rest.

In some embodiments, installation, implementation and deployment of a Wireless Sensor Network (WSN) facilitating managing wireless communication between the POV based display and one or more sensor nodes installed in at least one of residential, commercial and mixed-use infrastructures is disclosed, in accordance with the principles of the present invention.

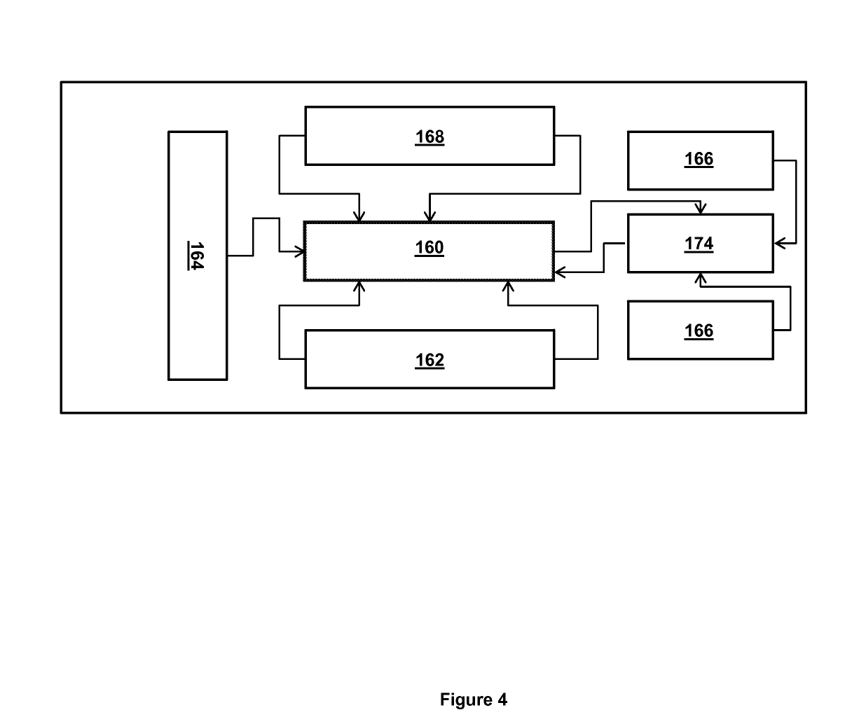

FIG. 4 depicts the architecture of a sensor node constituting the Wireless Sensor Network (WSN), according to one or more embodiments.

At least one of the networks 108 (not shown here explicitly) in the system 100 may be a WSN 108. The WSN 108 comprises of spatially distributed autonomous sensors to monitor at least one of physical, ambient and environmental parameters or conditions, such as at least one of acoustic, sound, vibration, chemical, electric current, electric potential, magnetic, radio, environment, weather, moisture, humidity, position, displacement, distance, speed, light, imaging, heat, temperature, proximity, presence, pressure, and a combination thereof, and to cooperatively pass the data through the WSN 108 to a main location, for instance the fan 102. In some embodiments, the WSN 108 may be capable of facilitating are bi-directional, also enabling control of the sensor activity.

Each of the sensor nodes 158 comprises a controller 160, an external memory 162, a power source 164, one or more sensors 166, an Analog-to-Digital Converter (ADC) 174 and a transceiver 168.

The controller 160 may be capable of performing tasks, processing data and controlling the functionality of the other components of the each of the sensor nodes 158. For example, and in no way limiting the scope of the invention, the controller 160 may be at least one of a microcontroller, microprocessor, Digital Signal Processor (DSPs), Field-Programmable Gate Array (FPGA) and Application-Specific Integrated Circuit (ASIC). In some scenarios, a microcontroller may be used in many embedded systems, such as sensor nodes, because of low cost, flexibility to connect to other devices, ease of programming, and low power consumption. In some scenarios, a microprocessor may be used. However, the microprocessor generally has higher power consumption than a microcontroller; therefore the microcontroller is often considered a suitable choice for a sensor node. In some scenarios, a DSP may be chosen for broadband wireless communication applications, but in WSN the wireless communication is often modest. For example, the wireless communication in WSN is simpler, easier to process modulation and the signal processing tasks of actual sensing of data is less complicated. Therefore, the advantages of DSPs are not usually of much importance to WSN. Further, a FPGA can be reprogrammed and reconfigured according to requirements, however reprogramming and reconfiguration consumes more time and energy than desired.

Sensor nodes often make use of Industrial, Scientific and Medical (ISM) band, which gives free radio, spectrum allocation and global availability. The possible choices of wireless transmission media are at least one of Radio Frequency (RF), optical communication (laser), infrared and a combination thereof. Lasers require less energy, but need line-of-sight for communication and are sensitive to atmospheric conditions. Infrared, like lasers, needs no antenna but Infrared is limited in broadcasting capacity. RF-based communication is the most relevant that fits most of the WSN applications. WSNs tend to use license-free communication frequencies, such as 173, 433, 868, 915 MHz and 2.4 GHz. In some embodiments, the functionality of both transmitter and receiver may be combined into the transceiver 168. The operational states of transceiver may be at least one of transmit, receive, idle, sleep and a combination thereof. In some scenarios involving deployment of current generation transceivers, some of the operations are performed automatically via utilization of the built-in state machines.

Memory requirements are application dependent. The external memory 162 may comprise a user memory 170 (not shown here explicitly) and a program memory 172 (not shown here explicitly). The user memory 170 may be capable of storing application related or personal data, whereas the program memory 172 may be capable of storing programming data for programming a device. For example, and by no way of limitation, the most relevant kinds of external memory 162 may be the on-chip memory of the microcontroller 160 and flash memory, for instance off-chip RAM. Flash memories are used due to their cost and storage capacity.

In some embodiments, the POV based display subsystem may be capable of facilitating display of context-independent multimedia information or contents, based on the multimedia information contents available in the IMDB of the memory unit of the microcomputer subsystem without any reference to, or irrespective of, the current context associated with the POV based display subsystem.

In some embodiments, the POV based display subsystem may be capable of facilitating display of context-dependent (or -sensitive), relevant peer multimedia information or contents, based on at least one of the multimedia information or contents received from one or more external networks and the multimedia information or contents currently being displayed on the POV based display subsystem with reference to, or relative to, at least one of a consolidated context, the current context associated with the POV based display subsystem, and a combination thereof.

In some embodiments, the POV based display subsystem may be capable of remaining in standby or sleep mode. In standby or sleep mode, the state of the microcomputer subsystem coupled to the POV based display subsystem, i.e. the fan, is held in a RAM of the memory unit. The microcomputer subsystem cuts off power supply to unneeded subsystems and places the RAM into a minimum power state, just sufficient to retain the data therein. The microcomputer subsystem may consume some energy while sleeping in order to power the RAM and to be able to respond to a wake-up events.

In some embodiments, the POV based display subsystem may be at least one of battery powered and electrically powered. In some scenarios involving battery powered and electrically powered POV based display subsystems, the blades of the fan (or POV based display subsystem) may rotate thereby facilitating generation of electrical energy via conversion of kinetic energy.

In some embodiments, the POV based display subsystem may be bidirectionally, communicably and operably coupled to one or more POV based display subsystems, for instance fans, thereby forming the system of the present invention. In some scenarios, in the event that a given first POV based display subsystem at a given first location is in at least one of sleep and standby mode, and wherein a user intends to practice the system in accordance with the principles of the present invention, the user may move to a given second POV based display subsystem located at a given second location different from the first and use the system.

### Example Computer System

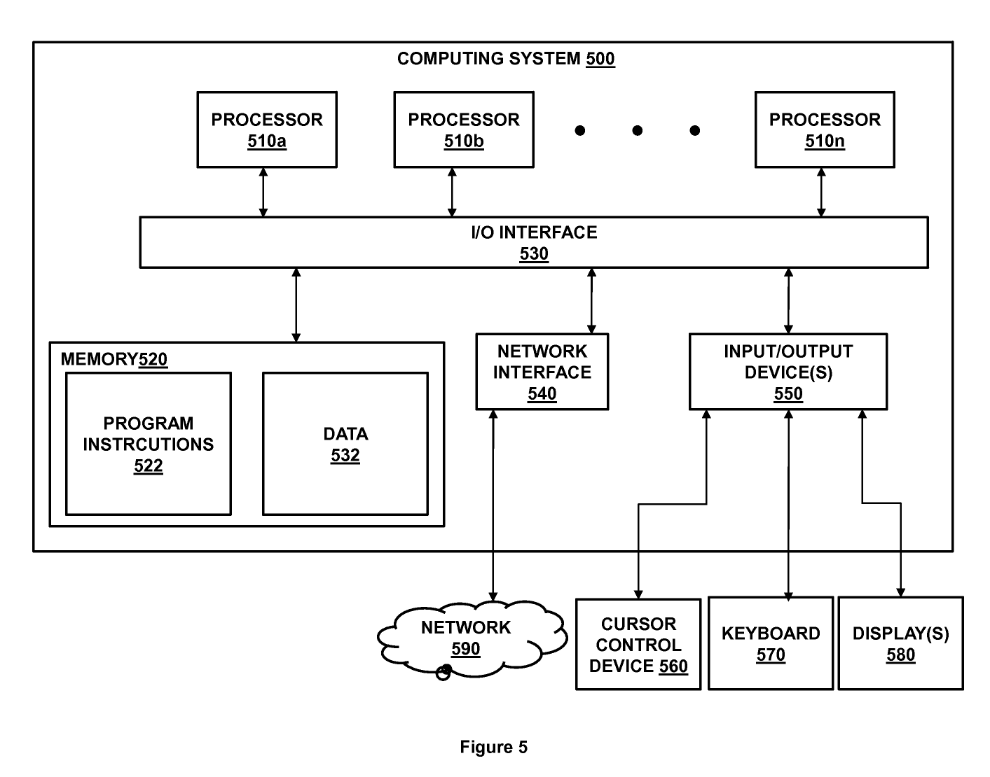

FIG. 5 depicts a computer system that is at least one of a portable computing and communications device and a microcomputer and can be utilized in various embodiments of the present invention, according to one or more embodiments.

Various embodiments of improved method and system for managing display of multimedia information on a Persistence Of Vision (POV) based display, as described herein, may be executed on one or more computer systems, which may interact with various other devices. One such computer system is computer system 500 illustrated by FIG. 5, which may in various embodiments implement any of the elements or functionality illustrated in FIGS. 1, 2, 3 and 4. In various embodiments, computer system 500 may be configured to implement one or more methods described above. The computer system 500 may be used to implement any other system, device, element, functionality or method of the above-described embodiments. In the illustrated embodiments, computer system 500 may be configured to implement one or more methods as processor-executable executable program instructions 522 (e.g., program instructions executable by processor(s) 510a-n) in various embodiments.

In the illustrated embodiment, computer system 500 includes one or more processors 510a-n coupled to a system memory 520 via an input/output (I/O) interface 530. The computer system 500 further includes a network interface 540 coupled to I/O interface 530, and one or more input/output devices 550, such as cursor control device 560, keyboard 570, and display(s) 580. In various embodiments, any of components may be utilized by the system to receive user input described above. In various embodiments, a user interface (e.g., user interface) may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510a-n may be any suitable processor capable of executing instructions. For example, in various embodiments processors 510 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 510a-n may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one components (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the methods described above. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A system for managing display of multimedia information comprising:
a Persistence Of Vision (POV) based display subsystem facilitating display of at least one of contextual and non-contextual multimedia information;
a microcomputer subsystem coupled to the POV based display subsystem for processing the at least one of contextual and non-contextual multimedia information;
an illumination subsystem for displaying the at least one of contextual and non-contextual multimedia information;
a portable computing and communication device for accessing and transmitting the at least one of contextual and non-contextual multimedia information from and to the microcomputer subsystem coupled to the POV display subsystem; and
an external network for transmitting the at least one of contextual and non-contextual multimedia information to the microcomputer subsystem coupled to the POV display subsystem.

2. The system of claim 1, wherein the POV display subsystem is a micro-computerized fan, and wherein the at least one of blade span and blade sweep of the fan serves as a medium for displaying the multimedia information.

3. The system of claim 2, wherein the fan is at least one of battery and electrically powered, and wherein the blades of the blades of the fan rotate thereby facilitating generation of electrical energy via conversion of kinetic energy.

4. The system of claim 2, wherein the fan comprises a GPS unit for facilitating determination of position or location of the fan and a GPRS unit for facilitating transmission and reception of at least one of visual, video, data, facsimile and multimedia information between the portable computing and communications device, external network and fan.

5. A method for managing of multimedia information comprising:
displaying at least one of contextual and non-contextual multimedia information on a Persistence Of Vision (POV) based display subsystem;
processing the at least one of contextual and non-contextual multimedia information using a microcomputer subsystem coupled to the POV based display subsystem;
displaying the at least one of contextual and non-contextual multimedia information using an illumination subsystem coupled to the POV based display subsystem;
accessing and transmitting the at least one of contextual and non-contextual multimedia information from and to the microcomputer subsystem coupled to the POV display subsystem using a portable computing and communication device; and
transmitting the at least one of contextual and non-contextual multimedia information to the microcomputer subsystem coupled to the POV display subsystem using an external network.

6. The method of claim 5, wherein the step of processing the at least one of contextual and non-contextual multimedia information using a microcomputer subsystem coupled to the POV based display subsystem further comprises:
storing overall profiles of the users of the POV based display subsystem, analyzing the captured overall profiles,
profiling the users based on the analysis of the captured overall profiles, categorizing the users based on the profiling,
utilizing the categorization information and contextual information in a given location in which the POV based display subsystem may be confined to build a current ambient context, and
rendering recommendations in connection with selection and display of one or more available multimedia information based on the categories of the users and current ambient context.
